(19) United States
(12) Patent Application Publication
(10) Pub. No.: US 2016/0176267 A1
(43) Pub. Date: Jun. 23, 2016

(54) VEHICLE AIR VENT DAMPER

(71) Applicant: NIFCO KOREA INC., Cheonan-si, Chungcheongnam-do (KR)

(72) Inventor: Yoon Hwan SHIN, Cheonan-si, Chungcheongnam-do (KR)

(21) Appl. No.: 14/909,375

(22) PCT Filed: Aug. 6, 2014
(86) PCT No.: PCT/KR2014/007274

§ 371 Date: Feb. 1, 2016

(30) Foreign Application Priority Data
Aug. 6, 2013 (KR) 10-2013-0093280

(51) Int. Cl. B60H 1/34; F24F 13/14

(52) U.S. Cl. CPC B60H 1/3414; F24F 13/14; B60H 2001/3464

(57) ABSTRACT

A vehicle air vent damper for controlling an amount of air being discharged into a vehicle room through an air vent, includes a working member including a hinge groove, an outer peripheral coupling groove fanned along an outer peripheral surface of the working member, a fixing part disposed on one side of the coupling groove, and including fitting grooves, and a base part disposed on another side of the coupling groove opposite to the one side in respect to the hinge groove, and including coupling hooks to be exposed through the fitting grooves; and a blocking pad including a coupling hole to fit into the outer peripheral coupling groove of the working member, and fitting holes formed at opposite portions of the blocking pad and receiving the corresponding coupling hooks.

### TECHNICAL FIELD

The present invention relates to a vehicle air vent damper, wherein the misassembling between a blocking pad made from a rubber material and a working member is prevented and the deformation of the blocking pad is minimized, thereby achieving the smooth operation of the damper and preventing the air leakage from the inside of an air vent.

### BACKGROUND

In general, a vehicle air vent is an air discharge means of an air conditioning system which appropriately maintains vehicle room temperature and is formed to control the air discharge by controlling a damper which is provided inside an air vent.

According to a conventional vehicle air vent damper, as disclosed in Korean Patent Laid-open Publication No. 10-2005-0018109, a damper provided inside an air vent can operate to open or close the air vent by the operation of a knob which is provided to the front surface of the air vent so as to be operated by a hand.

Further, referring to FIGS. 1 and 2, the damper includes: a blocking pad 100 made from a rubber material and having a securing part 120 formed in a traversal direction in a center thereof, a fitting hole 121 penetratingly formed in the center thereof, and coupling holes 110a, 110b respectively penetratingly formed in the upper and lower portions of the securing part 120; and

a working member 200 having a securing groove 210 formed in the traversal direction in the middle thereof such that the securing part 120 formed in the center of the blocking pad 100 is secured thereto, a misassembling preventing rib 211 protruding forward in the middle of the securing groove 210 so as to be inserted into the fitting hole 121 of the blocking pad 100, and coupling grooves 220 formed on an outside rim surface so as to be forcedly fitted into the coupling holes 110a, 110b in a state in which the rib 211 is inserted into the fitting hole 121.

At this time, the working member 200 has hinge grooves 250 at the upper and lower portions of the drawings so as to be rotationally coupled to the air vent 300, and the coupling grooves 220 are oppositely formed at both sides with reference to the hinge grooves 250 for facilitating the forced-fitting operations.

That is, as shown in FIG. 3, with reference to the hinge grooves 250 of the working member 200, the working member is formed such that the right front surface of the working member 200 is short while the right rear surface thereof has an extended length in the drawing and the left front surface of the working member 200 is long while the left rear surface thereof has a short distance. Therefore, the blocking pad 100 made from a rubber material is pulled in a state, in which the blocking pad 100 is fitted into the coupling groove 200 at one side, such that the forcedly-fitting of the blocking pad 100 into the coupling groove 200 at the other side is readily carried out.

In the conventional air vent damper described as above, in a state, in which the securing part 120 of the blocking pad 100 made from a rubber material is secured to the securing groove 210 of the working member 200 by the insertion of the misassembling preventing rib 211 into the fitting holes 121, the inside portions of the coupling holes 110a, 110b of the blocking pad 100 are inserted into the coupling grooves 220 of the working member 200, and the outside end portion of the blocking pad 100 is attached to or detached from the blocking step 311 of the blocking protrusion 310 which is provided to the air vent 300 such that the discharge mount of air which is introduced to a vehicle room through the air vent 300 can be controlled.

However, the conventional vehicle air vent damper has a disadvantage that it is necessary to penetratingly form the fitting holes in the center portion of the securing part and to penetratingly form the coupling holes in each of the upper and lower portions of the securing part such that the manufacturing of the molds for forming the blocking pad and the working process are added, increasing the manufacturing costs.

In addition, the conventional vehicle air vent damper has a disadvantage that it is necessary to form the securing groove in the center of the working member and to protrudingly form the misassembling preventing rib for preventing the misassembling of the blocking pad with respect to the securing groove such that the strength of the center portion of the working member is weakened and is likely to be deformed, decreasing the reliability of the product.

### PRIOR ART DOCUMENT

### Patent Document

Patent Document 1: Korean Patent Laid-open Publication No. 10-2005-0018109, Air vent damper, published on 23 Feb. 2005

### SUMMARY OF INVENTION

### Technical Problem

The present invention has been made so as to resolve the above-described problems, and its objective is to provide a vehicle air vent damper, wherein a blocking pad made from a rubber material can be easily and conveniently coupled to a working member simultaneously improving the strength of the working member, thereby restraining the deformation thereof.

Another objective of the present invention is to provide a vehicle air vent damper, wherein misassembling preventing ribs and holes are asymmetrically provided to the right and left portions of a working member and a blocking pad, thereby reducing the blocking pad assembling time and work.

### Solution to Problem

In order to achieve the above and any other objectives of the present invention, a vehicle air vent damper, in which a blocking pad 10 forcedly fitted into an outer peripheral coupling groove 22 of a working member 20 which is rotationally hinge-coupled to the inside of an air vent 30 is held by the blocking step 31a of a blocking protrusion 31, which is provided inside the air vent 30, at an end thereof such that the rotation of the blocking pad 10 is controlled so as to control the discharge amount of air which is introduced into a vehicle room through the air vent 30, characterized in that:

the working member 20 has a coupling groove 22 formed along the outer peripheral surface thereof, a base part 24 formed to have a fixing part 23 which is short on one surface of a coupling groove 22 while the fixing part 23 extends long on the other surface of the coupling groove 22 such that the right side and the left side with reference to a hinge groove 25 are opposite to each other, and fitting grooves 23a depressed inward on the right and left ends of the fixing part 23, and the base part 24 formed to further have coupling hooks 24a to be exposed through the fitting grooves 23a; and

the blocking pad 10 has a coupling hole 11 formed in the middle thereof so as to be forcedly fitted into the coupling groove 22 of the working member 20, and fitting holes 12 formed at both right and left sides thereof so as to be fitted into the coupling hooks 24a.

Further, the fitting grooves 23a and the coupling hooks 24a formed at the both right and left sides of the working member 20 are located at different horizontal positions on the right and left sides of the working member 20, and the coupling hooks 24a are formed to have vertical surfaces on the insides thereof and to protrude to the outsides with an inclination.

### Advantageous Effects of Invention

A vehicle air vent damper according to the present invention in the above configuration can simplify the assembling process by forcedly fitting the blocking pad along the outer peripheral surface of the working member and omitting any additional securing groove which has been formed in the middle portion of the working member in the conventional art, thereby simplifying the manufacturing of molds and working process while reducing manufacturing costs thereof.

Further, the coupling hooks provided to the both right and left sides of the working member are inserted into the coupling holes provided to the blocking pad, thereby stably coupling the blocking member to the working member without any misassembling.

Therefore, the blocking pad which is fitted into the coupling hooks is prevented from the escaping to the outside and the deformation thereof while the damper is in operation and the air leakage of the air vent can be prevented when the damper is closed.

### BRIEF DESCRIPTION OF DRAWINGS

FIG. 1 is an exploded perspective view showing the structure of a conventional vehicle air vent damper.

FIG. 2 is a side view showing the mounting state of the conventional air vent damper.

FIG. 3 is a plan view showing the working member of the conventional air vent damper.

FIG. 4 is an exploded perspective view of a vehicle air vent damper according to a preferred embodiment of the present invention.

FIG. 5 is a side view showing the mounting state of the air vent damper according to the present invention, and

FIG. 6 is a plan view showing the working member of the air vent damper according to the present invention.

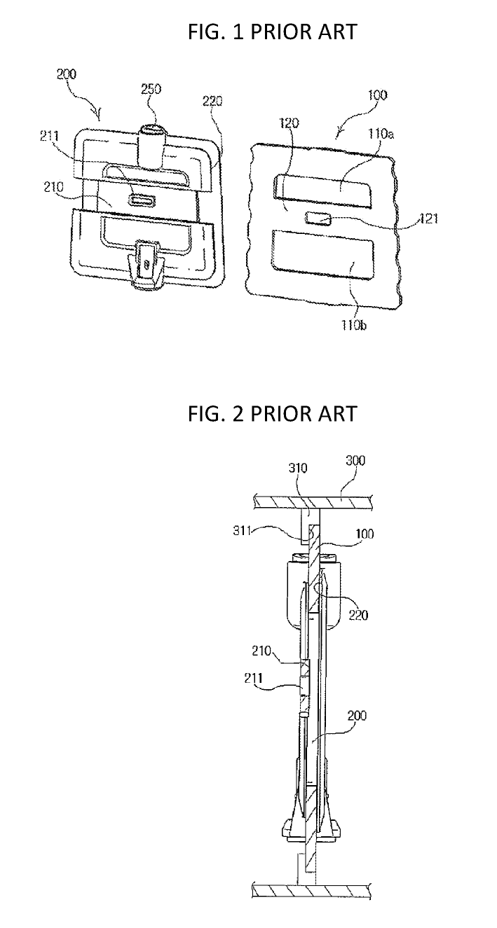

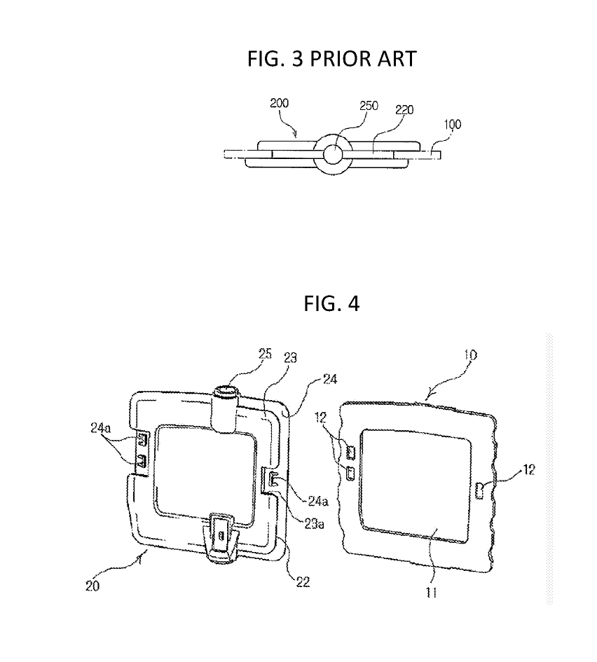

### BEST MODE FOR CARRYING OUT THE INVENTION

Hereinafter, embodiments of the present invention will now be described with respect to the configuration in detail with reference to the drawings.

A vehicle air vent damper according to the present invention prevents the misassembling of a blocking pad 10 made from a rubber material and a working member 20 while minimizing the deformation of the blocking pad 10 so as to enable a damper to smoothly operate and to prevent the leakage of air from the inside of an air vent.

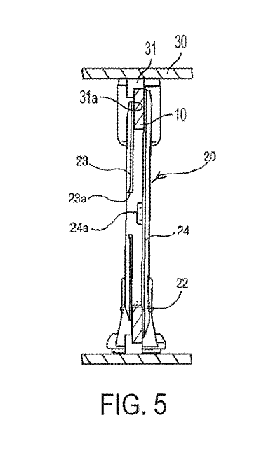

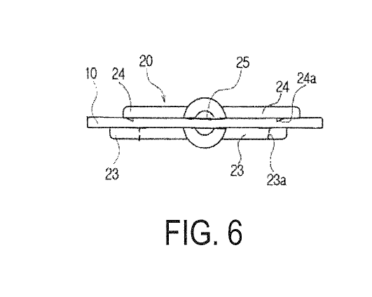

First, approximately explaining the reference of directions used in the description with reference to FIG. 4 and FIG. 5, a damper to which the technique of the present invention is applied, a blocking pad 10 forcedly fitted into the outer peripheral coupling groove 22 of a working member 20 which is rotationally hinge-coupled to the inside of an air vent 30 is held by the blocking step 31a of a blocking protrusion 31, which is formed inside the air vent, at one end such that the rotation of the blocking pad 10 is controlled and the discharge amount of air which is introduced into a vehicle room through the air vent 30 can be controlled.

Herein, the working member 20 has a coupling groove 22 formed along the outer peripheral surface thereof, a base part 24 formed to have a fixing part 23 which is short on one surface of a coupling groove 22 while the fixing part 23 extends long on the other surface of the coupling groove 22 such that the right side and the left side with reference to a hinge groove 25 are opposite to each other, and fitting grooves 23a depressed inwards on the right and left ends of the fixing part 23, and the base part 24 formed to further have coupling hooks 24a to be exposed through the fitting grooves 23a.

Further, the blocking pad 10 has a coupling hole 11 formed in the middle thereof so as to be forcedly fitted into the coupling groove 22 of the working member 20, and fitting holes 12 further formed at both right and left sides thereof so as to be fitted into the coupling hooks 24a.

The working member 20 and the blocking pad 10 are provided with the two coupling hooks 24a and the two fitting holes 12 at one side, and provided with one coupling hooks 24a and one fitting hole 12 at the other side so as to prevent the misassembling of the blocking pad 10.

According to another embodiment of the present invention for preventing the misassembling, the fitting grooves 23a and the coupling hooks 24a formed at both right and lefts sides of the working member 20 are preferably located at different horizontal positions of the right and left sides for the forcedly-fitting of the blocking pad 10.

Furthermore, the coupling hooks 24a are formed to have vertical surfaces on the insides thereof and to protrude to the outsides with an inclination such that the coupling can be readily carried out in the process of forcedly fitting the blocking pad 10 while preventing the escape of the blocking pad 10 by the holding of the coupling hooks 24a during the operation of the damper.

Now, the assembling procedure of the air vent damper configured as above will be described in more detail.

The coupling hole 11 of the blocking pad 10 is forcedly fitted into the coupling groove 22 formed along the outer peripheral surface of the working member 20.

At this time, the two coupling hooks 24a formed at one side of the working member 20 are inserted into the two fitting holes 12 formed at one side of the blocking pad 10, while the one coupling hook 24a formed at the other side of the working member 20 is inserted into the fitting hole 12 formed at the other side of the blocking pad 10, thereby preventing the misassembling of the blocking pad 10 and improving the stable coupling of the blocking pad 10.

In explaining an example of use of the working member 20 to which coupled the blocking pad 10 is coupled as above, the discharge amount of air which is introduced into a vehicle room through the air vent 30 can be controlled by the working member 20 which rotates with respect to the hinge groove 25 axially coupled to the air vent 30 while the outside end portion of the blocking pad 10 is attached to or detached from the blocking step 31a of the blocking protrusion 31 provided to the air vent 30.

Therefore, in order to block the air which is introduced into the vehicle room through the air vent 30, the working member 20 rotates with respect to the hinge groove 25 such that the outside end portion of the blocking pad 10 is fitted into the blocking step 31a of the blocking protrusion 31 provided to the air vent 30.

Meanwhile, in order to introduce air into the vehicle room through the air vent 30, the working member 20 rotates with respect to the hinge groove 25 such that the outside end portion of the blocking pad 10 separates from the blocking step 31a of the blocking protrusion 31 provided to the air vent 30.

The embodiments described above are to be understood as a few illustrative examples of the present invention. It will be understood by those skilled in the art that various modifications, combinations and changes may be made to the embodiments without departing from the scope of the present invention.

### BRIEF EXPLANATION OF REFERENCE SYMBOLS

10—Blocking pad 11—Coupling holes

12—Fitting hole 20—Working member

22—Coupling groove 23—Fixing part

23a—Fitting groove 24—Base part

24a—Coupling hook 25—Hinge groove

30—Air vent 31—Blocking protrusion

31a—Blocking step

1-3. (canceled)

4. A vehicle air vent damper for controlling an amount of air being discharged into a vehicle room through an air vent, comprising:
a working member including
a base part having a first coupling hook on one lateral side and a second coupling hook on another lateral side opposite to the one lateral side,
a fixing part disposed on a side of the base part to overlap therewith and having a first fitting groove facing the first coupling hook and a second fitting groove facing the second coupling hook,
a coupling groove formed between the base part and the fixing part to surround the working member, and
hinge portions disposed at peripheral portions of the working member to span the base part and the fixing part and arranged between the first and second coupling hooks, and
a blocking pad disposed between the base part and the fixing part around the coupling groove, and having
a coupling hole to fit into the coupling groove of the working member, and
a first fitting hole facing the first coupling hole and a second fitting hole facing the second coupling hole, said first and second fitting holes fitting into the corresponding first and second coupling hooks.

5. The vehicle air vent damper according to claim 4, wherein the first fitting groove and the first coupling hook of the working member on the one lateral side are disposed at positions different than those on the another lateral side in a horizontal direction of the working member.

6. The vehicle air vent damper according to claim 4, wherein each of the first and second coupling hooks has a vertical surface on an inner side of the working member and protruding toward the fixing part with an inclination.
